(19) United States
(12) Patent Application Publication
(10) Pub. No.: US 2025/0365461 A1
(43) Pub. Date: Nov. 27, 2025

(54) DYNAMIC STREAMING SCHEDULING FOR MULTI-CONTENT DELIVERY NETWORKS

(71) Applicant: Bytedance Technology Ltd., Grand Cayman (KY)

(72) Inventors: Yanlin ZHOU, Los Angeles, CA (US); Yingan WANG, Los Angeles, CA (US); Chaitanya Bandikatla, Los Angeles, CA (US); Daniel Hieu Phan, Los Angeles, CA (US); Jianling GONG, Los Angeles, CA (US)

(21) Appl. No.: 19/294,908

(22) Filed: Aug. 8, 2025

(51) Int. Cl. H04N 21/262

(52) U.S. Cl. CPC H04N 21/26216

(57) ABSTRACT

In one embodiment, a method of streaming scheduling for a plurality of content delivery networks includes: for each content delivery network of the plurality of content delivery networks, receiving a plurality of parameters at least from the content delivery network, wherein the plurality of parameters is processed into a plurality of metrics; identifying a scheduling scene for the content delivery network; determining a weight for each metric of the plurality of metrics based on the scheduling scene; determining a scheduling score for the content delivery network based on the plurality of metrics and the respective weights; and based on the scheduling score of each content delivery network of the plurality of content delivery networks, allocating a content delivery event among the plurality of content delivery networks.

### TECHNICAL FIELD

This disclosure generally relates to live streaming of digital content, and in particular relates to systems and methods for dynamic streaming scheduling for multi-content delivery networks (multi-CDNs).

### BACKGROUND

Live streaming platforms commonly rely on content delivery networks (CDNs) to intake, record, and distribute digital content. Traditional scheduling of streaming events typically uses static rules or single-layer decision-making to allocate content among the CDNs. However, as streaming platforms scale to support a growing number of concurrent broadcasters or viewers, these simplistic approaches struggle to account for dynamic changes. In particular, they lack the ability to coordinate decisions across different layers in a unified manner. Thus, there is a need for a streaming scheduling solution that is capable of responding effectively to sudden traffic bursts while dynamically balancing various parameters such as, for example, network capacity, service quality, and operational cost.

### SUMMARY

In particular embodiments, a method includes: for each content delivery network of the plurality of content delivery networks, receiving a plurality of parameters at least from the content delivery network, the plurality of parameters being processed into a plurality of metrics; identifying a scheduling scene for the content delivery network; determining a weight for each metric of the plurality of metrics based on the scheduling scene; determining a scheduling score for the content delivery network based on the plurality of metrics and the respective weights; and based on the scheduling score of each content delivery network of the plurality of content delivery networks, allocating a content delivery event among the plurality of content delivery networks.

In particular embodiments, one or more computer-readable non-transitory storage media are provided. The storage media embody software that is operable when executed to perform operations including: for each content delivery network of the plurality of content delivery networks, receiving a plurality of parameters at least from the content delivery network, the plurality of parameters being processed into a plurality of metrics; identifying a scheduling scene for the content delivery network; determining a weight for each metric of the plurality of metrics based on the scheduling scene; determining a scheduling score for the content delivery network based on the plurality of metrics and the respective weights; and based on the scheduling score of each content delivery network of the plurality of content delivery networks, allocating a content delivery event among the plurality of content delivery networks.

In particular embodiments, a system includes one or more processors and one or more computer-readable non-transitory storage media coupled to one or more of the processors. The storage media include instructions operable when executed by one or more of the processors to cause the system to perform operations including: for each content delivery network of the plurality of content delivery networks, receiving a plurality of parameters at least from the content delivery network, the plurality of parameters being processed into a plurality of metrics; identifying a scheduling scene for the content delivery network; determining a weight for each metric of the plurality of metrics based on the scheduling scene; determining a scheduling score for the content delivery network based on the plurality of metrics and the respective weights; and based on the scheduling score of each content delivery network of the plurality of content delivery networks, allocating a content delivery event among the plurality of content delivery networks.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system, and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example network environment for content delivery services.

FIG. 2 illustrates an example system for scheduling content streaming among multiple content delivery networks.

FIG. 3 illustrates an example tiered scheduling scheme for egress events.

FIG. 4 illustrates an example tiered scheduling scheme for ingest events.

FIG. 5 illustrates an example flow chart of a method for streaming scheduling over multiple content delivery networks.

FIG. 6 illustrates an example computer system.

### DETAILED DESCRIPTION

Live streaming platforms, as well as other digital content delivery platforms, may be required to deliver millions of concurrent content streams while maintaining extremely low first-frame delay and minimal playback stall time. To meet these performance demands at scale, the streaming platforms may typically rely on content delivery architectures that are tightly integrated. For example, a typical content delivery system in this context may include three functional layers. Specifically, for example, the first layer may be an ingress or ingest layer, where broadcasters push real-time content streams—such as real-time messaging protocol (RTMP) streams—into one or more entry points associated with the content delivery networks. The second layer may be an origin processing layer, in which the raw content streams may be transcoded, packaged, and stored, such as either in an origin cluster managed by the streaming platform or in a commercial content delivery network that supports just-in-time (JIT) transcoding. And finally, the third layer may be the egress or delivery layer, where end-user clients may pull the requested digital content—typically formatted as Flash Video (FLV), HTTP Live Streaming (HLS), or Dynamic Adaptive Streaming over HTTP (DASH) segments—from respective content delivery networks, which may be geographically distributed worldwide.

To provide scalable and resilient streaming services, the streaming platforms may commonly employ a multi-CDN architecture that aggregates multiple edge points of presence (PoPs) and data centers from multiple third-party providers, along with the streaming platform's own in-house content delivery network. For example, in this case, the network capacity may typically be provisioned to accommodate approximately one to two times the expected daily traffic peak to ensure sufficient headroom during surges.

In certain scenarios, it may be desirable to dynamically schedule content streaming among multiple content delivery networks to achieve a balanced trade-off among different factors such as network capacity, service quality, and operational cost. To this end, particular embodiments of the disclosure may incorporate various streaming scheduling techniques. For instance, content steering may be utilized, which may be configured to operate at the session or segment level, whereby user requests may be directed to an optimal content delivery network (or an endpoint of the network), using manifest rewriting or Domain Name System (DNS) based routing logic, for example. In particular embodiments, Adaptive Bitrate (ABR) streaming may also be employed, enabling user devices to dynamically select the highest quality content rendition that the current network conditions are able to support. In addition, particular embodiments may take into account usage-based billing models (such as percentage-based peak bandwidth billing) or per-byte traffic billing that are typically adopted by commercial content delivery network services, which may affect cost efficiency and scheduling strategy. Furthermore, particular embodiments disclosed herein may implement extensive quality monitoring, capturing various real-time quality indicators, such as quality of service (QOS) parameters.

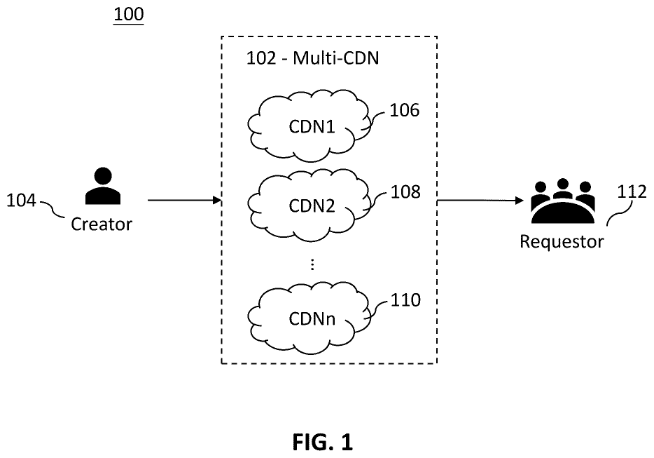

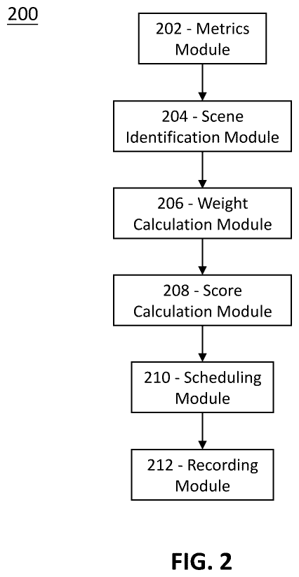

FIG. 1 illustrates an example network environment 100 for delivering digital content in a multi-CDN architecture. In this example, a user or content creator 104 may initiate a digital content streaming event—such as a live video feed—from a user device, which may be transmitted to multiple content delivery networks, collectively referred to herein as multi-CDN 102. The multi-CDN 102 may include any suitable number of individual content delivery networks, such as CDN1 106, CDN2 108, through CDNn 110. Each of these content delivery networks CDN1 106, CDN2 108, through CDNn 110 may include a set of geographically distributed nodes or edge servers operable to ingest, process the content streams, and deliver them to one or more user devices associated with various content requestors 112. In practice, however, the participating content delivery networks in the multi-CDN 102 may differ in terms of network capacity, service quality, operational cost, and other associated streaming parameters. For example, one content delivery network may exhibit lower latency but impose higher per-byte delivery costs, while another may have surplus capacity and resource availability but experience jitter. Moreover, various streaming parameters of each content delivery network may fluctuate over time, for example, due to concurrent streaming demand. Accordingly, a dynamic streaming scheduling solution is desirable that is capable of responding effectively to sudden traffic bursts while dynamically balancing various parameters such as, for example, network capacity, service quality, and operational cost., details of which will be explained further in the below with reference to FIG. 2.

As used herein, the term “content” may include any suitable type of data, regardless of its representation and regardless of what the data represents. The term “content” may include, without limitation, text, images (e.g., static and/or dynamic images), audio content (including streamed audio), video content (including streamed video), and the like. Some content may be embedded in other content, e.g., using markup languages such as HTML and XML. The user device may be described herein as a smartphone, but the user (e.g., the content creator or requestor) may use any suitable types of computing devices to access the content delivery network, including, but not limited to, a tablet, a laptop computer, a desktop computer, a cell phone, a wearable computing device, a gaming device, etc.

FIG. 2 illustrates an example system 200 for scheduling content streaming among multiple content delivery networks. In particular embodiments, the system 200 may include a metrics module 202. The metrics module 202 may be configured to receive one or more parameters from one or more content delivery networks, one or more user devices associated with the content delivery networks, or other suitable devices or systems involved in content delivery. In particular embodiments, the parameters may include one or more capacity parameters associated with the content delivery networks. As an example and not by way of limitation, each of the content delivery networks may be configured to report its own network capacity to the metrics module 202. The capacity parameters may include data indicative of the content delivery network's remaining bandwidth, available processing or storage resources, or other measurable capacity indicators associated with the current service load or provisioning status of the content delivery network. The capacity parameters may include, without limitation, push concurrency and/or push capacity, transcoding load and/or transcoding capacity, pull bandwidth and/or pull capacity, or other suitable parameters. As an example and not by way of limitation, each of the content delivery networks may be configured to periodically or conditionally transmit its capacity parameters to the metrics module 202 so as to facilitate coordination of content scheduling across multiple content delivery networks. Although this disclosure describes a system for scheduling content streaming with particular capacity parameters in a particular manner, this disclosure contemplates systems for scheduling content streaming with any suitable capacity parameters in any suitable manner.

In particular embodiments, the parameters may also include one or more quality parameters associated with the content delivery network and/or one or more user devices, which, for example, may be in communication with the content delivery network. As an example and not by way of limitation, the user devices may be equipped with software applications such as a client-side software development kit (SDK) to collect service parameters associated with the user device and/or the content delivery network. For example, the quality parameters may include one or more quality of service (QOS) parameters. The QoS parameters may include, without limitation, push success rate, pull success rate, Supplemental Enhancement Information (SEI) delay, stall ratio (such as stall time per 100 second), latency, packet loss, jitter, or other service quality indicators experienced in real time by the user device during operation (such as during content transmission or playback with the content delivery network). Additionally or alternatively, in particular embodiments, the quality parameters associated with the user device may include a server-side or network-side (such as CDN-side) image quality assessment, such as a peak signal-to-noise ratio (PSNR) score, which reflects the fidelity of delivered visual content over the content delivery network. In particular embodiments, these quality parameters may be useful in providing feedback on performance or service quality experienced by the users. Although this disclosure describes a system for scheduling content streaming with particular quality parameters in a particular manner, this disclosure contemplates systems for scheduling content streaming with any suitable quality parameters in any suitable manner.

In particular embodiments, the parameters may additionally include one or more cost parameters associated with the content delivery networks. As an example and not by way of limitation, one or more real-time cost parameters (or signals) associated with each of the content delivery networks may be monitored and reported to the metrics module 202. Specifically, for instance, the cost parameters may include, without limitation, a current bandwidth unit price, an accumulated delivery cost (e.g., over a certain time interval), or a notification indicating a change in pricing by the content delivery network, thereby enabling a cost-aware optimization of downstream content routing. Although this disclosure describes a system for scheduling content streaming with particular cost parameters in a particular manner, this disclosure contemplates systems for scheduling content streaming with any suitable cost parameters in any suitable manner.

In particular embodiments, subsequent to data ingestion from the different sources described, for example, the received parameters (e.g., the capacity parameters associated with the content delivery networks, the quality parameters associated with the user devices and/or the content delivery networks, and the cost parameters associated with the content delivery networks) may be processed. This may be done via the metrics module 202 or other suitable modules of the system 200 (such as a scene identification module 204, as will be discussed in more detail below). As an example and not by way of limitation, data preprocessing may be performed, which may include denoising to remove outliers (e.g., by utilizing interquartile range filtering, Z-score detection, etc.), data interpolation for missing or corrupted fields, time-series alignment using timestamp normalization, and other suitable data preprocessing techniques. In particular embodiments, the parameters may further be fused, organized, and aggregated from multi-dimensional data into a unified metric representation for more efficient downstream processing. As an example and not by way of limitation, the received parameters may be aggregated, based on their category or functional relevance, into respective metrics, including such as a capacity metric indicative of a network capacity associated with the content delivery network, a quality metric indicative of a service quality associated with the content delivery network, and a cost metric indicative of an operational cost associated with the content delivery network.

In particular embodiments, based on the aggregated metrics, a scene identification module 204 may be utilized to analyze the metrics and determine a current operational scenario or “scene” in which the digital content is delivered. As an example and not by way of limitation, scene identification may employ rule-based logic, machine learning models, or other suitable techniques to classify, based on the received parameters or the aggregated metrics, the system's status into different scene categories. In particular embodiments, the categories may be predefined or dynamically learned. In particular embodiments, the categories may at least include, for example, a burst scene and a normal scene. As an example and not by way of limitation, a burst scene may correspond to periods of sudden traffic surges, abnormal cost spikes, or rapid degradation in client-perceived quality of service, while a normal scene may correspond to relatively stable traffic levels, consistent cost profiles, and satisfactory user experience indicators.

In particular embodiments, to accurately categorize the current scene as either a burst scene or a normal scene, the scene identification module 204 may be configured to calculate a burst coefficient. The calculation of the burst coefficient may be based on the received parameters or the aggregated metrics, such as those related to the network capacity. As an example and not by way of limitation, the burst coefficient may be calculated as a ratio of a current total egress bandwidth value (“TotalEgressBw”) to a rolling average bandwidth over a defined historical time window, such as the previous fifteen minutes (“RollingAvgBw 15m”). Specifically, for example, the burst coefficient may be expressed as:

$$Burst Coefficient = TotalEgressBw / RollingAvgBw 15 m \qquad ( 1 )$$

In particular embodiments, if the computed burst coefficient is greater than or equal to a threshold value, the scene identification module 204 may then classify the current scene that the associated content delivery network is experiencing as a burst scene. Otherwise, if the computed burst coefficient remains below the threshold value, the current scene may be identified by the scene identification module 204 as a normal scene. In particular embodiments, the threshold value may be a predefined, fixed value. Alternatively, in particular embodiments, the threshold value may be configurable based on system tolerance or operational policy, for example.

In particular embodiments, to enhance contextual accuracy, the scene identification module 204 may additionally reference historical traffic data over an extended timeframe. As an example and not by way of limitation, the scene identification module 204 may reference the past twenty-four hours to validate the scene identification in order to avoid misclassification due to short-term fluctuations.

In particular embodiments, the identified scene may be output from the scene identification module 204 to a weight calculation module 206. The weight calculation module 206 may be a dynamic weight calculator configured to dynamically assign relative weights to various metrics or parameters—such as network capacity, service quality, and operational cost—based at least on the scene identified by the scene identification module 204. In particular embodiments, the weight calculation module 206 may be configured to assign a weight vector that defines a prioritization of scheduling objectives under the current scene. As an example and not by way of limitation, in a burst scene characterized by sudden traffic spikes or limited network availability, a weight assigned to network capacity may be increased to a dominant level, followed by the quality metric (e.g., latency, packet loss), with cost placed at a lower priority. Conversely, as an example and not by way of limitation, in a normal scene, a higher weight may be assigned to the quality metric to ensure optimal and stable user experience, followed by cost efficiency, with network capacity given lower importance.

In particular embodiments, the weight calculation module 206 may utilize a static table that maps various scenes—such as burst scene and normal scene—to corresponding sets of weights associated with each parameter (e.g., network capacity, service quality, and operational cost). As an example and not by way of limitation, in a burst scene, the weight calculation module 204 may apply a weight of 0.7 to the capacity metric, 0.2 to the quality metric, and 0.1 to the cost metric, thereby prioritizing network availability during traffic surges. In contrast, as an example and not by way of limitation, in a normal scene, the weight calculation module 204 may assign weights of 0.2 to the capacity metric, 0.5 to the quality metric, and 0.3 to the cost metric, thus favoring user experience under a desired cost efficiency. The aforementioned examples of the weight profile are summarized in Table 1 below. It should be noted that although this disclosure describes streaming scheduling with a particular weight profile having particular values, this disclosure contemplates streaming scheduling with any suitable weight profiles having any suitable values, such as any suitable weight values from zero to one.

TABLE 1

| Scene | Capacity Weight | Quality Weight | Cost Weight |
|---|---|---|---|
| Burst | 0.7 | 0.2 | 0.1 |
| Normal | 0.2 | 0.5 | 0.3 |

In particular embodiments, the weight profiles may be stored in a static configuration. Alternatively, in particular embodiments, the weight profiles may be dynamically generated and tunable in real time. In particular embodiments, although not shown, the weight profiles may be extended to support multi-dimensional configurations that take into account additional or auxiliary contextual factors such as geographic region, time of day, content type, network tier, or other suitable considerations. As an example and not by way of limitation, different geographic regions of the content delivery networks may define distinct weight combinations, based on, for example, regional cost structures, historical service quality characteristics, or other suitable factors. In particular embodiments, the appropriate weight profiles may be determined by resolving the current identified scene in combination with the auxiliary contextual factors, making it especially suitable for large-scale content delivery environments requiring a more fine-grained scheduling.

In particular embodiments, once the suitable weights are determined and assigned, a score calculation module 208 may be configured to compute a comprehensive scheduling score for each candidate content delivery network based on the assigned weights (which are determined in response to the current identified scene, as already discussed). As an example and not by way of limitation, the scheduling score may be derived using a weighted formula that incorporates normalized values of multiple metrics indicative of network capacity, service quality, as well as operational cost. In particular embodiments, a scheduling score S for a given content delivery network (or each of the content delivery networks) may be calculated according to the following expression:

$$S = CapacityWeight \times CapacityNormalization + QualityWeight \times QualityNormalization + CostWeight \times ( 1 - CostNormalization ) \qquad ( 2 )$$

where CapacityWeight, QualityWeight, and CostWeight represent the dynamically assigned weights for network capacity, service quality, and operational cost, respectively; CapacityNormalization, QualityNormalization, and CostNormalization represent the normalized values of network capacity, service quality, and operational cost, respectively.

In particular embodiments, to ensure that the scheduling score S reflects accurate and interpretable prioritization across different metrics, the normalization directions for network capacity, service quality, and operational cost metrics are made consistent. Specifically, in particular embodiments, according to equation (2), cost normalization may be inverted such that a content delivery network with a lower operational cost may yield higher scores. For example, the normalized value of cost may be transformed using a complement function, such as (1-CostNormalization), thereby ensuring that a lower cost contributes positively to the overall scheduling score S. In other words, without such a reversal, directly applying a positive weight to a standard cost normalization (where higher costs yield higher values) may inadvertently bias the scheduling score S in favor of content delivery networks with higher costs, resulting in a less desirable scheduling allocation.

The following describes example embodiments of a cost normalization algorithm for calculating the CostNormalization value of equation (2) above. In particular embodiments, a cost normalization algorithm is implemented to quantify and compare the incremental cost associated with delivering digital content via different content delivery networks. The algorithm may operate in multiple stages to accommodate varying pricing models. In particular embodiments, in the first stage, the algorithm may identify the billing mode associated with each of the content delivery networks. As an example and not by way of limitation, if the content delivery network uses a traffic-based billing model, the incremental cost (ΔCost) associated with content allocation may be calculated by multiplying the price per gigabyte by the total amount of traffic delivered in gigabytes. Specifically, the expression of incremental cost (ΔCost) may be expressed as:

$$Δ Cost = PricePerGB \times TrafficInGb \qquad ( 3 )$$

In particular embodiments, if the content delivery network uses a percentile-based (“Pxx”) billing model, such as 95^{th} percentile (P95) bandwidth billing, the algorithm may first compute the excess bandwidth beyond a committed peak within a certain time period (e.g., a committed monthly peak). This excess bandwidth, referred to herein as “OverBandwidth,” may be calculated as the greater of zero and the difference between the total bandwidth consumed and the monthly peak threshold, for example. This is expressed by the following:

$$OverBandwidth = max ( 0 , TrafficInGb - MonthlyPeakInGB ) \qquad ( 4 )$$

Under this percentile-based billing model, the incremental cost (ΔCost) may then be computed by multiplying the overage by the per-gigabyte rate:

$$Δ Cost = PricePerGB \times OverBandwidth \qquad ( 5 )$$

In this case, for example, if a content delivery network has not yet exceeded its monthly billing threshold (e.g., its P95 baseline), the algorithm may determine that ΔCost=0, thereby prioritizing that content delivery network for additional traffic due to its lower marginal cost.

In particular embodiments, in the second stage, a normalized cost value may be derived to enable direct comparison across multiple content delivery networks. In particular embodiments, the cost per gigabyte may first be calculated by dividing the incremental cost (ΔCost) by the corresponding traffic volume:

$$CostPerGB = Δ C ost / TrafficInGb \qquad ( 6 )$$

In particular embodiments, the resulting CostPerGB value may then be normalized using min-max scaling across all candidate content delivery networks, as indicated by the following:

$$Normalized Cost = \frac{CostPerGB - Min CostCDN}{Max CostCDN - Min CostCDN + i} \qquad ( 7 )$$

Here, i may represent a small non-zero constant (e.g., 10⁻⁹) introduced to prevent division by zero when the maximum and minimum cost values are equal. Computed this way, the normalized cost value thus may represent a unitless metric between 0 and 1, where lower values correspond to more cost-effective content delivery network options.

In particular embodiments, normalization of the quality metrics may be performed by aggregating various quality parameters—such as push success rate, pull success rate, SEI delay, stall ratio (e.g., stall time per 100 seconds), PSNR—into a composite value, which may be then normalized. In particular embodiments, capacity normalization, on the other hand, may be calculated based on the available free capacity of each content delivery network, which, for example, may be expressed as a percentage (e.g., available bandwidth relative to maximum capacity) and then normalized. For example, relevant capacity parameters of interest may include, but are not limited to, push concurrency and/or push capacity, transcoding load and/or transcoding capacity, pull bandwidth and/or pull capacity, or other suitable parameters. Although this disclosure describes metric normalization with particular normalization techniques in a particular manner, this disclosure contemplates metric normalization with any suitable normalization techniques in any suitable manner. In this regard, for example, in particular embodiments, the normalization may be performed using techniques such as min-max scaling, z-score normalization, domain-specific transformation, or the like, so as to ensure comparability across different parameters and metrics among all candidate content delivery networks.

In particular embodiments, based on the computed scheduling score for each of the content delivery networks, a scheduling module 210 may be configured to generate a delivery strategy. As an example and not by way of limitation, the delivery strategy may include allocating a content delivery event among multiple content delivery networks, such as a selection of a target content delivery network from the content delivery networks for initiating a new user session, reallocation of traffic in response to changing network or cost conditions, disaster recovery switching in the event of severe quality degradation or service failure. In particular embodiments, the delivery strategy may be generated using various logics (such as threshold-based calculation, score differentials, priority rankings across content delivery networks within a given region or service domain).

In particular embodiments, the scheduling module 210 may also be configured to define one or more conditional triggers that activate specific scheduling responses. As an example and not by way of limitation, a trigger may be configured to reassign traffic when the scheduling score of the currently-selected content delivery network falls below a defined threshold, or when a scheduling score of a competing content delivery network exceeds the scheduling score of the currently-selected content delivery network. In particular embodiments, the scheduling strategy may be updated in real time and may support rollback or failover paths to ensure high availability and service continuity. In particular embodiments, once determined, the delivery strategy may be returned to the relevant content delivery network(s) and/or user devices for execution.

In particular embodiments, the scheduling module 210 may employ a tiered mitigation strategy that may be dynamically activated based on the current scene in which the content delivery network is operating—such as a burst scene or a normal scene as determined by the scene identification module. In particular embodiments, based on the identified scene, the scheduling module 210 may apply two separate but parallel tiered schemes corresponding to different content delivery events: for example, one for egress (pull) event for transmitting a digital content stream to a user device and another for ingest (origin) event for receiving a digital content stream from a user device. As an example and not by way of limitation, each tiered scheme may be governed by a workflow-based state machine that defines tiered scheduling steps, escalation thresholds, rollback logics, and so forth, to ensure controlled and reversible transitions.

In particular embodiments, when no capacity risks are detected—i.e., in a normal scene, for example, the scheduling module 210 may operate in a quality-and cost-centric logic. As an example and not by way of limitation, under this mode, the scheduling module 210 may use a weighted cost/quality-based allocation, where the scheduling module 210 may distribute or allocate new content streaming events to the content delivery network(s) with the highest composite scheduling score (i.e., the scheduling score S). In particular embodiments, the allocation percentages may be configurable (e.g., 20%, 50%, or 100%), thereby allowing a particular percentage of the new content streaming events to be directed to the desired content delivery network(s). In particular embodiments, because the network capacity is assumed to be sufficient, the mode under the normal scene may not necessarily trigger aggressive scheduling allocation or mitigation actions or mass user migrations.

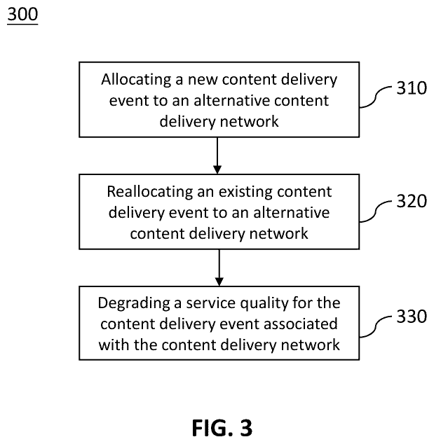

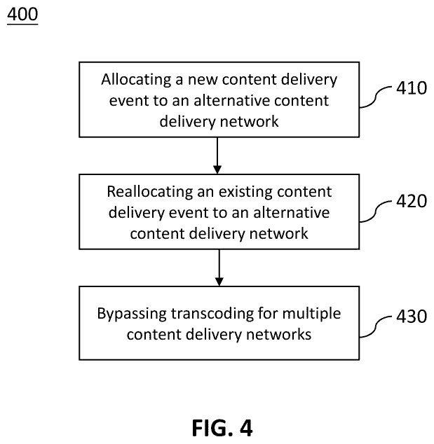

On the other hand, in particular embodiments, when a burst scene is identified, depending on the delivery events (e.g., the egress events or the ingest events), the scheduling module 210 may initiate a corresponding capacity-centric tiered scheme for activating content scheduling and mitigation steps in a tiered and escalating sequence depending on severity, which will be described in greater details below with reference to FIGS. 3 and 4.

FIG. 3 illustrates an example tiered scheduling scheme 300 applicable by the scheduling module 210 for the egress events. At a first tier 310, in particular embodiments, if the capacity metric of a given content delivery network exceeds a first threshold (such as 60% of the rated capacity), the scheduling module 210 may be configured to allocate the new content delivery event (e.g., a new user session) to an alternative content delivery network. Specifically, for example, the scheduling module 210 may be configured to trigger hot-stream rebalancing, in which the top number of most popular (hot) streams in the relevant region may be selectively redistributed to alternative content delivery networks based on their respective scheduling scores. This action may be intended to absorb incremental traffic while preserving a high cache-hit ratio.

At a second tier 320, in particular embodiments, if the network capacity continues to rise despite the hot-stream rebalancing, such as when the capacity metric of the content delivery network exceeds a second threshold, the scheduling module 210 may be configured to reallocate an existing content delivery event to an alternative content delivery network. For instance, the scheduling module 210 may be configured to escalate to content steering, wherein the manifest or DNS configurations for existing content streaming events or user sessions are updated to redirect playback to alternative content delivery networks with lower utilization. This mid-session migration may provide fast relief for the overloaded content delivery network(s).

At a third tier 330, which may be the most severe tier of the scheduling scheme 300, in particular embodiments, when the capacity metric of the content delivery network exceeds a third threshold (such as 90% of the rated capacity), the scheduling module 210 may be configured to degrade a service quality for the content delivery event associated with the content delivery network. For instance, the scheduling module 210 may enable bit-rate degradation for the most bandwidth-intensive streams. In particular embodiments, lower-bit-rate renditions may be activated selectively while maintaining a minimum rendition quality threshold. For example, the quality threshold may be monitored through peak signal-to-noise ratio (PSNR) checks conducted at specific time intervals, such as every five seconds. As an example and not by way of limitation, if the PSNR quality drops below a predefined threshold, the scheduling module 210 may initiate a rollback logic to step back to a higher-quality rendition of the content stream. In particular embodiments, each degradation level and corresponding recovery operation may be managed by a workflow state machine that is configured to track the tiered status and generate gradual or stepwise rollback as capacity conditions improve.

FIG. 4 illustrates an example tiered scheduling scheme 400 applicable by the scheduling module 210 for the ingest events. The scheduling scheme 400 associated with the ingest events may be performed in parallel to the scheduling scheme 300 associated with the egress events. At a first tier 410, in particular embodiments, if the ingest concurrency on any individual content delivery network is determined to reach or exceed a first threshold, such as 70% of its rated capacity, the scheduling module 210 may trigger multi-CDN ingest balancing, in which selected broadcasters or users (such as new user sessions) are assigned to alternative ingest content delivery networks based on their respective scheduling scores. In particular embodiments, the redistribution may continue until all participating content delivery networks report ingest concurrency or capacity below a safety threshold (such as 60% of a rated capacity).

At a second tier, in particular embodiments, a transcoding capacity for a particular content delivery network may be monitored. If the transcoding usage for the content delivery network exceeds a safety threshold, the scheduling module 210 may perform cross-CDN transcode migration to reassign the corresponding existing content stream to an alternative content delivery network. In particular embodiments, the migration decision may be based on both the estimated impact on streaming quality (e.g., PSNR) and the different cost (ΔCost) associated with the reassignment.

At the final, third tier, in particular embodiments, if all of the content delivery networks report transcoding usage above the safety threshold, the scheduling module 210 may initiate transcode bypass, in which transcoding for all content delivery networks is bypassed. In other words, the affected content streams are delivered directly to their source format without transcoding. In particular embodiments, this bypass tier may remain active until an overall transcoding capacity falls below a certain threshold (e.g., 70% of a rated capacity), at which point the full scheduling scheme 400 is re-enabled, and the content streams that were bypassed may be progressively reintroduced into the transcoding workflow.

In particular embodiments, the scheduling module 210 may incorporate one or more rollback or stability rules designed to ensure controlled recovery from the burst scene to the normal scene operations and to prevent oscillation or instability (for example, during transitions between different scheduling tiers). In particular embodiments, after entering the burst scene and triggering various mitigation actions, the scheduling module 210 may not immediately revert to operations under the normal scene once the network capacity subsides. Instead, in particular embodiments, the scheduling module 210 may be configured to apply a fade-out mechanism, wherein the assigned weights used in the score calculation module 208—such as the weights associated with the capacity, quality, and cost (CapacityWeight, QualityWeight, and CostWeight)—may gradually shift back from the values in the burst scene to their normal scene values. Such a shift may be linear and/or may occur over a specific transition window, for example. This reduces the risk of abrupt traffic redistribution and allows the content scheduling to adapt stably to varying conditions.

In particular embodiments, the rollback of individual mitigation actions may follow a tiered, one-step-at-a-time policy. As an example and not by way of limitation, the highest tier currently in effect (i.e., the tier with the most severity, such as the third, bit-rate degradation tier 330) may be rolled back first, while lower tiers (e.g., the second, content steering tier 320 or the first, hot-stream rebalancing tier 310) may remain active until the system metrics, particularly the capacity metric, confirm sustained recovery. In particular embodiments, for further rollback to proceed, certain conditions may be met. For instance, where PSNR-based service quality thresholds were used to trigger a specific tier, the scheduling module 210 may verify that the PSNR remains above a threshold value for the entire duration of a cooldown window (e.g., 60 seconds) before restoring the original bitrate or shifting the mitigation tier.

These rollback rules may ensure that the content scheduling prioritizes low-cost mitigation tiers—such as exploiting unused “Pxx” billing headroom—then selectively migrates only the traffic that provides the most significant capacity relief, and finally resorts to the most aggressive tier, like bit-rate degradation. In this way, the tiered scheduling schemes 300 and 400 may be implemented in a tightly controlled and reversible manner, thereby maintaining service continuity with minimized incremental delivery cost, even during and after traffic surges.

Additionally, in particular embodiments, a recording module 112 may be configured to log the current operational scene and the corresponding scheduling strategy, for example, into a system state machine or state management database. For instance, a system state machine or state management database may function as a computational model that represents discrete operational states or behavior of the system and may be configured to govern transitions between those states, for example, based on real-time metrics or events. As an example and not by way of limitation, the recording module 112 may be configured to store a structured record of historical transitions between system states, such as the identified scene type, the calculated weights, the selected content delivery network, and the generated scheduling strategy. This may facilitate traceability of the scheduling, allowing relevant parties or authorized personnel, such as automated agents or system operators, to analyze historical decision logic, detect anomalies, or perform other suitable analyses.

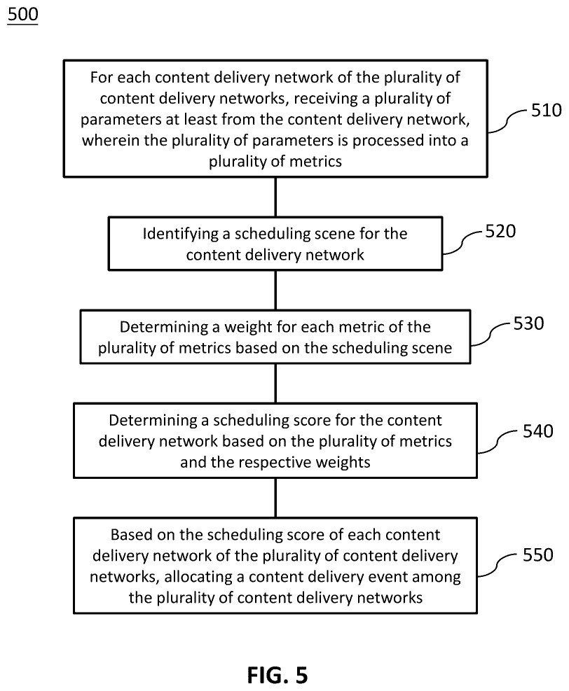

FIG. 5 illustrates a process flow of an example method 500 for streaming scheduling over multiple content delivery networks. The method 500 may incorporate similar steps described above with reference to FIGS. 2-4 and may be compatible with various embodiments disclosed herein. The method 500 may begin at step 510, where multiple parameters are received at least from each of the content delivery networks. Additionally, one or more parameters (such as those related to the service quality delivered by the content delivery network) may also be received from a user device associated with the content delivery network. In particular embodiments, the parameters may include one or more capacity parameters indicative of a network capacity associated with the content delivery network, one or more quality parameters indicative of a service quality associated with the content delivery network, and one or more cost parameters indicative of an operational cost associated with the content delivery network. In particular embodiments, the received parameters may be processed or aggregated into respective metrics. Correspondingly, in particular embodiments, the aggregated metrics may include a capacity metric indicative of a network capacity associated with the content delivery network, a quality metric indicative of a service quality associated with the content delivery network, and a cost metric indicative of an operational cost associated with the content delivery network. In particular embodiments, the metrics may be normalized to facilitate further calculation and processing.

At step 520, a scheduling scene may be identified for the content delivery network. As an example and not by way of limitation, the scheduling scene may include a burst scene, indicating that the content delivery network is experiencing heavy streaming traffic, and a normal scene, corresponding to stable and light traffic flow. The scheduling scene may be determined based on one or more of the received parameters or aggregated metrics. For instance, the scheduling scene may be determined based on one or more capacity parameters, such as a total egress bandwidth and a rolling average bandwidth, as indicated by equation (1) discussed above.

At step 530, based on the scheduling scene, a weight may be determined for each of the metrics. In particular embodiments, the weight assigned to each metric under different scenes may be different. For example, in a burst scene, greater weight may be determined for the capacity metric, whereas in a normal scene, the quality metric may be assigned greater weight. In particular embodiments, the weight may be retrieved from a static table that defines predetermined weight profiles corresponding to different scenes and metric types.

In particular embodiments, the weight for each of the metrics may be dynamically adjustable based on the scheduling scene. As an example and not by way of limitation, a change in the scheduling scene—such as a transition from a burst scene to a normal scene as streaming traffic subsides—may be determined. In response to the change, the weight for each metric may be adjusted to reflect the changing condition. In particular embodiments, the weight may be gradually adjusted, such as in a linear manner or over a certain time period.

At step 540, a scheduling score may be determined for the content delivery network. The scheduling score may be computed based on the metrics and their respective weights. As an example and not by way of limitation, the scheduling score may be calculated in accordance with equation (2) described above. In this manner, a single composite score may be generated for each content delivery network, representing a weighted evaluation of multiple metrics, including the capacity metric, the quality metric, and the cost metric.

At step 550, based on the scheduling score of each of the content delivery networks, a content delivery event may be allocated among the multiple content delivery networks. In particular embodiments, the content delivery event may include an ingest event for receiving a digital content stream from a user device or an egress event for transmitting a digital content stream to a user device. In particular embodiments, the scheduling scores of the multiple content delivery networks may be ranked. The content delivery event may be allocated to a particular content delivery network based on the ranking. As an example and not by way of limitation, one or more content delivery events (such as new streaming sessions) may be allocated to one or more content delivery networks having higher scheduling scores. In particular embodiments, the content delivery event may be allocated to the content delivery network having the highest scheduling score.

In particular embodiments, the allocation of the content delivery event among the content delivery networks may be based on the current scheduling scene. In this regard, for example, different scheduling schemes for the allocation of the content delivery event may be applied depending on whether the system is operating in a burst scene or a normal scene. As an example and not by way of limitation, in a normal scene, one or more content delivery events may be proportionally assigned to the content delivery networks based on their scheduling scores. By comparison, as an example and not by way of limitation, in a burst scene, the content delivery event may be allocated among the content delivery networks in a tiered manner, such as corresponding to those described above with reference to FIGS. 3 and 4.

In particular embodiments, allocating the content delivery event among the content delivery networks may include one or more of allocating a new content delivery event to a particular content delivery network or reallocating an existing content delivery event to an alternative content delivery network. This may be determined based on the associated capacity metrics, for example. In particular embodiments, a determination may be made on whether the capacity metric for a particular content delivery network exceeds a first threshold. If the capacity metric for the content delivery network exceeds the first threshold, a new content delivery event may be allocated to an alternative content delivery network. In particular embodiments, a determination may be made on whether the capacity metric for a particular content delivery network exceeds a second threshold. If the capacity metric for a particular content delivery network exceeds the second threshold, an existing content delivery event may be reallocated to an alternative content delivery network.

In particular embodiments, a determination may be made on whether the capacity metric for a particular content delivery network exceeds a third threshold. Based on determining that the capacity metric for the particular content delivery network exceeds the third threshold, a service quality for the content delivery event associated with the particular content delivery network may be degraded. For example, such degradation may be applied to an egress event. In particular embodiments, degrading the service quality may occur only after the capacity metric reaches a highest or most severe threshold and after other mitigating approaches—such as allocating a new content delivery event to an alternative content delivery network or reallocating an existing content delivery event to an alternative content delivery network—have already been applied.

In particular embodiments, a determination may be made on whether a transcoding capacity for a particular content delivery network exceeds a first threshold. The transcoding capacity may be determined based on the multiple parameters received from the content delivery networks. Based on determining that the transcoding capacity for the particular content delivery network exceeds the first threshold, an existing content delivery event may be reallocated to an alternative content delivery network. As an example and not by way of limitation, this may be applied to an ingest event. In particular embodiments, a determination may be made on whether a transcoding capacity for each content delivery network exceeds the first threshold. Based on determining that the transcoding capacity for each content delivery network exceeds the first threshold, all transcoding operations across the content delivery networks may be bypassed. In particular embodiments, bypassing transcoding may occur only after the transcoding capacity reaches a highest or most severe threshold and after other mitigating approaches—such as allocating a new content delivery event to a particular content delivery network or reallocating an existing content delivery event to an alternative content delivery network—have already been applied.

In particular embodiments, the allocation of the content delivery event among the content delivery networks may be recorded in a system state machine or a state management database for traceability. This may be especially useful for later tracking of the allocation history and supports rollback functionality, enabling the system to revert to the previous operation if necessary.

Particular embodiments may repeat one or more steps of the method of FIG. 5, where appropriate. Although this disclosure describes and illustrates particular steps of the method of FIG. 5 as occurring in a particular order, this disclosure contemplates any suitable steps of the method of FIG. 5 occurring in any suitable order. Moreover, although this disclosure describes and illustrates an example method for streaming scheduling over multiple content delivery networks including the particular steps of the method of FIG. 5, this disclosure contemplates any suitable method for streaming scheduling over multiple content delivery networks including any suitable steps, which may include all, some, or none of the steps of the method of FIG. 5, where appropriate. Furthermore, although this disclosure describes and illustrates particular components, devices, or systems carrying out particular steps of the method of FIG. 5, this disclosure contemplates any suitable combination of any suitable components, devices, or systems carrying out any suitable steps of the method of FIG. 5.

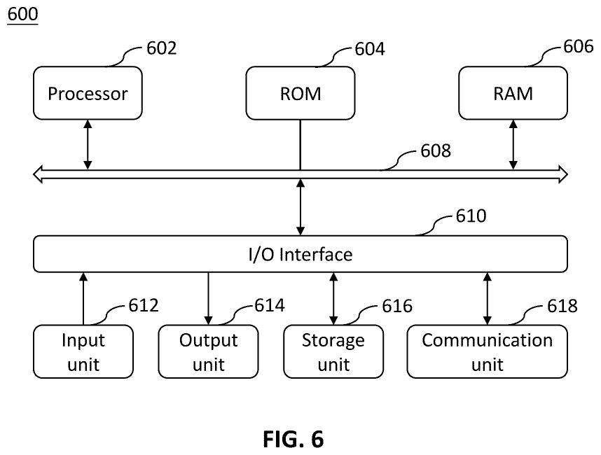

FIG. 6 illustrates a schematic block diagram of a computer system 600 that may be used to implement embodiments of the present disclosure. The computer system 600 may be the device or apparatus described in the embodiments of the present disclosure. As shown in FIG. 6, the computer system 600 includes a processor 602, which may be configured to execute various appropriate actions and processing to perform the methods (e.g., the method 500) of the present disclosure. The processor 602 is implemented in hardware, firmware, or a combination of hardware and software. In addition, although not shown in FIG. 6, the computer system 600 may also include a co-processor.

The processor 602 may execute actions and processing to perform the methods of the present disclosure according to computer program instructions. The computer program instructions for performing the operations of the present disclosure may be assembly instructions, Instruction Set Architecture (ISA) instructions, machine instructions, machine-related instructions, microcode, firmware instructions, status setting data, or source code or object code written in any combination of one or more programming languages, including object-oriented programming languages as well as conventional procedural programming languages. In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or more blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or more blocks in the flow charts and/or block diagrams.

The computer-readable program instructions may also be loaded onto a computer, other programmable data processing apparatuses, or other devices, such that a series of operating steps may be executed on the computer, the other programmable data processing apparatuses, or the other devices to produce a computer-implemented process, such that the instructions executed on the computer, the other programmable data processing apparatuses, or the other devices may implement the functions/actions specified in one or more blocks in the flow charts and/or block diagrams.

The computer program instructions may be stored in a Read-Only Memory (ROM) 604 or be loaded onto a Random Access Memory (RAM) 606 from a storage unit 616, for example. The processor 602, the ROM 604, and the RAM 606 are connected to each other via bus 608. An input/output (I/O) interface 610 is also connected to bus 608. The various methods or processes described above may be performed by the processor 602.

A plurality of components in computer system 600 are connected to the I/O interface 610, including: an input unit 612, such as a keyboard and a mouse; an output unit 614, such as various types of displays and speakers; the storage unit 616, such as a magnetic disk and an optical disc; and a communication unit 618, such as a network card, a modem, and a wireless communication transceiver. The communication unit 618 allows the computer system 600 to exchange information/data with other devices via a computer network, such as the Internet, and/or various telecommunication networks.

In some embodiments, the methods and processes described above may be implemented as a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer readable storage medium may be, but is not limited to, an electrical storage device, a magnetic storage device, an optical storage device, an electromagnetic storage device, a semiconductor storage device, or any suitable combination of the above. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disc (DVD), a memory stick, a floppy disk, a mechanical coding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices, or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The flow charts and block diagrams in the drawings illustrate the architectures, functions, and operations of possible implementations of the devices, methods, and computer program products according to various embodiments of the present disclosure. In this regard, each block in the flow charts or block diagrams may represent a module, a program segment, or part of an instruction, and the module, program segment, or part of an instruction includes one or more executable instructions for implementing specified logical functions. In some alternative implementations, functions marked in the blocks may also occur in an order different from those marked in the accompanying drawings. For example, two consecutive blocks may in fact be executed substantially concurrently, and sometimes they may also be executed in a reverse order, depending on the functions involved. It should be further noted that each block in the block diagrams and/or flow charts, as well as a combination of blocks in the block diagrams and/or flow charts, may be implemented using a dedicated hardware-based system that executes specified functions or actions, or using a combination of special hardware and computer instructions.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A method comprising:
for each content delivery network of the plurality of content delivery networks, receiving a plurality of parameters at least from the content delivery network, wherein the plurality of parameters is processed into a plurality of metrics;
identifying a scheduling scene for the content delivery network;
determining a weight for each metric of the plurality of metrics based on the scheduling scene;
determining a scheduling score for the content delivery network based on the plurality of metrics and the respective weights; and
based on the scheduling score of each content delivery network of the plurality of content delivery networks, allocating a content delivery event among the plurality of content delivery networks.

2. The method of claim 1, wherein the plurality of metrics includes a capacity metric indicative of a network capacity associated with the content delivery network, a quality metric indicative of a service quality associated with the content delivery network, and a cost metric indicative of an operational cost associated with the content delivery network.

3. The method of claim 1, wherein the scheduling scene comprises a burst scene or a normal scene.

4. The method of claim 1, wherein the scheduling scene is determined based on one or more of the plurality of parameters.

5. The method of claim 1, wherein the plurality of parameters is further received from a user device associated with the content delivery network.

6. The method of claim 1, wherein the plurality of metrics is normalized.

7. The method of claim 1, further comprising:
ranking the scheduling scores of the plurality of content delivery networks, wherein the content delivery event is allocated to a particular content delivery network of the plurality of content delivery networks based on the ranking.

8. The method of claim 1, wherein the content delivery event is allocated to a particular content delivery network of the plurality of content delivery networks having the highest scheduling score.

9. The method of claim 1, wherein the content delivery event includes an ingest event for receiving a digital content stream from a user device or an egress event for transmitting a digital content stream to a user device.

10. The method of claim 1, wherein the content delivery event is allocated among the plurality of content delivery networks in a tiered manner.

11. The method of claim 1, wherein allocating the content delivery event among the plurality of content delivery networks comprises one or more of:
allocating a new content delivery event to a particular content delivery network of the plurality of content delivery networks; or
reallocating an existing content delivery event to an alternative content delivery network of the plurality of content delivery networks.

12. The method of claim 1, further comprising:
determining whether a capacity metric of the plurality of metrics for a particular content delivery network of the plurality of content delivery networks exceeds a threshold; and
based on determining that the capacity metric for the particular content delivery network exceeds the threshold, degrading a service quality for the content delivery event associated with the particular content delivery network.

13. The method of claim 1, further comprising:
determining whether a transcoding capacity for a particular content delivery network of the plurality of content delivery networks exceeds a threshold; and
based on determining that the transcoding capacity for the particular content delivery network exceeds the threshold, reallocating an existing content delivery event to an alternative content delivery network of the plurality of content delivery networks.

14. The method of claim 1, further comprising:
determining whether a transcoding capacity for each content delivery network of the plurality of content delivery networks exceeds a threshold; and
based on determining that the transcoding capacity for each content delivery network exceeds the threshold, bypassing transcoding for the plurality of content delivery networks.

15. The method of claim 1, wherein the weight for each metric of the plurality of metrics is adjustable based on the scheduling scene.

16. The method of claim 15, further comprising:
determining a change in the scheduling scene for the content delivery network; and
based on the change in the scheduling scene, adjusting the weight for each metric of the plurality of metrics.

17. The method of claim 16, wherein the weight is gradually adjusted.

18. The method of claim 1, further comprising:
recording the allocation of the content delivery event among the plurality of content delivery networks in a system state machine or a state management database for traceability.

19. One or more computer-readable non-transitory storage media embodying software that is operable when executed to perform operations comprising:
for each content delivery network of the plurality of content delivery networks, receiving a plurality of parameters at least from the content delivery network, wherein the plurality of parameters is processed into a plurality of metrics;
identifying a scheduling scene for the content delivery network;
determining a weight for each metric of the plurality of metrics based on the scheduling scene;
determining a scheduling score for the content delivery network based on the plurality of metrics and the respective weights; and
based on the scheduling score of each content delivery network of the plurality of content delivery networks, allocating a content delivery event among the plurality of content delivery networks.

20. A system comprising:
one or more processors; and
one or more computer-readable non-transitory storage media coupled to one or more of the processors and comprising instructions operable when executed by one or more of the processors to cause the system to perform operations comprising:
for each content delivery network of the plurality of content delivery networks, receiving a plurality of parameters at least from the content delivery network, wherein the plurality of parameters is processed into a plurality of metrics;
identifying a scheduling scene for the content delivery network;
determining a weight for each metric of the plurality of metrics based on the scheduling scene;
determining a scheduling score for the content delivery network based on the plurality of metrics and the respective weights; and
based on the scheduling score of each content delivery network of the plurality of content delivery networks, allocating a content delivery event among the plurality of content delivery networks.
